(19) United States
(12) Patent Application Publication
(10) Pub. No.: US 2004/0077303 A1
(43) Pub. Date: Apr. 22, 2004

(54) Ventilation system for removal of hair spray fumes

(76) Inventors: Leslie D. Masser, Frederick, MD (US); Pearl E. Masser, Frederick, MD (US)

Correspondence Address: LINGBECK PATENT LAW OFFICE, P.O. BOX 500, ST. MICHAEL, MN, 55376, US

(21) Appl. No.: 10/274,554

(22) Filed: Oct. 21, 2002

(51) Int. Cl. B08B 15/02

(52) U.S. Cl. 454/67

(57) ABSTRACT

A ventilation system for removal of hair spray fumes for removing hair spray fumes from a particular room. The ventilation system for removal of hair spray fumes includes a fume passage assembly including a tubular conduit being adapted to be mounted to a building structure such as a ceiling, and also including a hood being attached at an end of the tubular conduit; and also includes an assembly of drawing fumes through the hood and the tubular conduit.

### BACKGROUND OF THE INVENTION

1. Field of the Invention

The present invention relates to bathroom ventilation systems and more particularly pertains to a new ventilation system for removal of hair spray fumes for removing hair spray fumes from a particular room.

2. Description of the Prior Art

The use of bathroom ventilation systems is known in the prior art. More specifically, bathroom ventilation systems heretofore devised and utilized are known to consist basically of familiar, expected and obvious structural configurations, notwithstanding the myriad of designs encompassed by the crowded prior art which have been developed for the fulfillment of countless objectives and requirements.

The prior art includes inventions having vents and fans disposed in the vents with switches being used to activate the fans. However, the vents are not adjustable, and are disposed either in the wall or in the ceiling. The prior art does not disclose a new ventilation system for removal of hair spray fumes.

### SUMMARY OF THE INVENTION

The general purpose of the present invention, which will be described subsequently in greater detail, is to provide a new ventilation system for removal of hair spray fumes which has many of the advantages of the bathroom ventilation systems mentioned heretofore and many novel features that result in a new ventilation system for removal of hair spray fumes which is not anticipated, rendered obvious, suggested, or even implied by any of the prior art bathroom ventilation systems, either alone or in any combination thereof. The present invention includes a fume passage assembly including a tubular conduit being adapted to be mounted to a building structure such as a ceiling, and also including a hood being attached at an end of the tubular conduit; and also includes an assembly of drawing fumes through the hood and the tubular conduit. None of the prior art includes an adjustable hood for bringing the hood in close proximity to where the fumes are being given off.

There has thus been outlined, rather broadly, the more important features of the ventilation system for removal of hair spray fumes in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new ventilation system for removal of hair spray fumes which has many of the advantages of the bathroom ventilation systems mentioned heretofore and many novel features that result in a new ventilation system for removal of hair spray fumes which is not anticipated, rendered obvious, suggested, or even implied by any of the prior art bathroom ventilation systems, either alone or in any combination thereof.

Still another object of the present invention is to provide a new ventilation system for removal of hair spray fumes for removing hair spray fumes from a particular room.

Still yet another object of the present invention is to provide a new ventilation system for removal of hair spray fumes that is easy and convenient to set up and use.

Even still another object of the present invention is to provide a new ventilation system for removal of hair spray fumes that can be positioned proximate to where the hair spray is being applied so that the fumes can be immediately removed from the room.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a side elevational view of a new ventilation system for removal of hair spray fumes according to the present invention.

FIG. 2 is a partial side elevational view of the present invention.

FIG. 3 is a schematic diagram of the present invention.

FIG. 4 is a side elevational view of a second embodiment of the present invention.

FIG. 5 is a cross-sectional view of the second embodiment of the present invention.

FIG. 6 is another cross-sectional view of the second embodiment of the present invention.

### DESCRIPTION OF THE PREFERRED EMBODIMENT

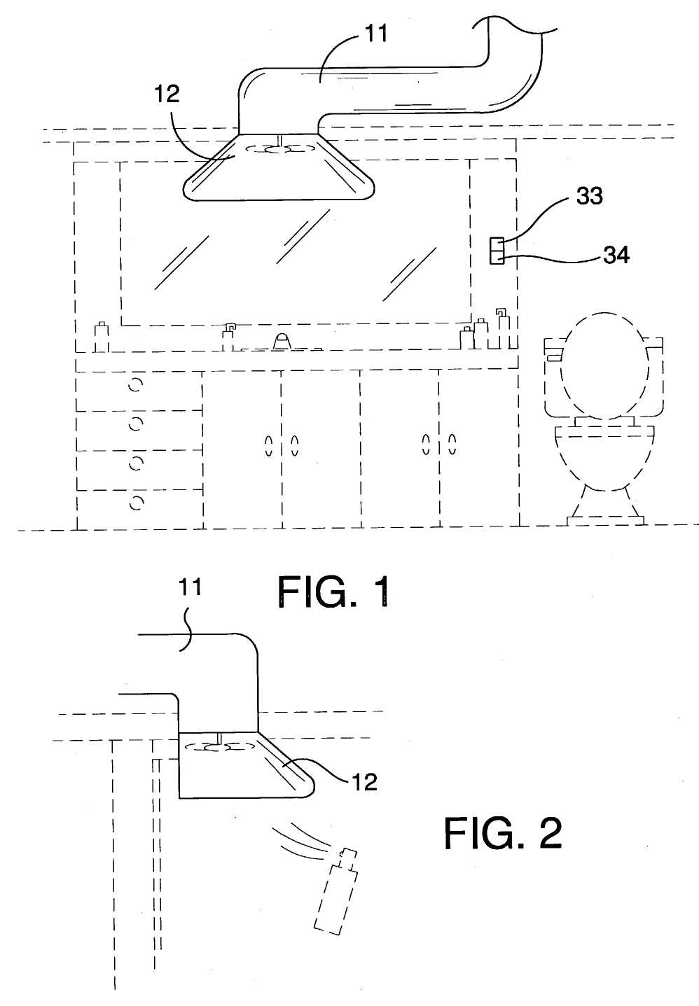

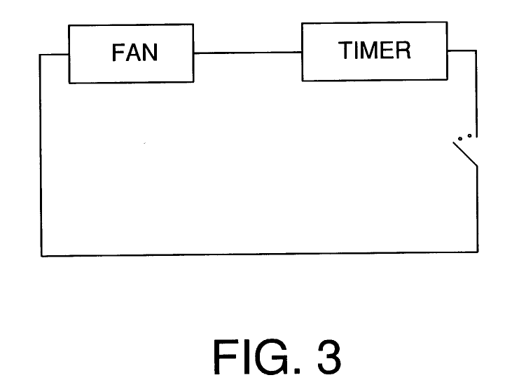

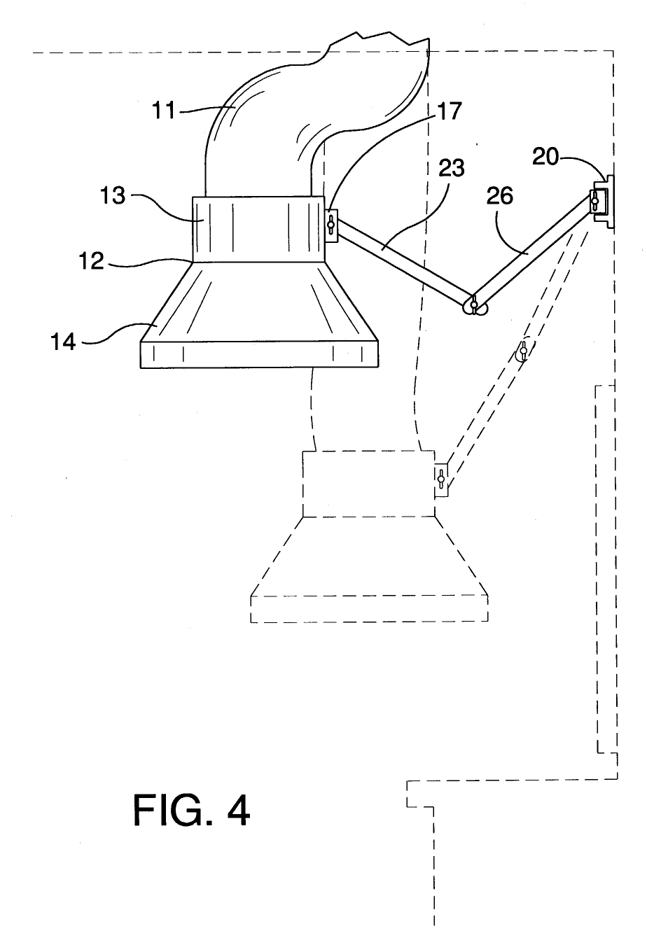

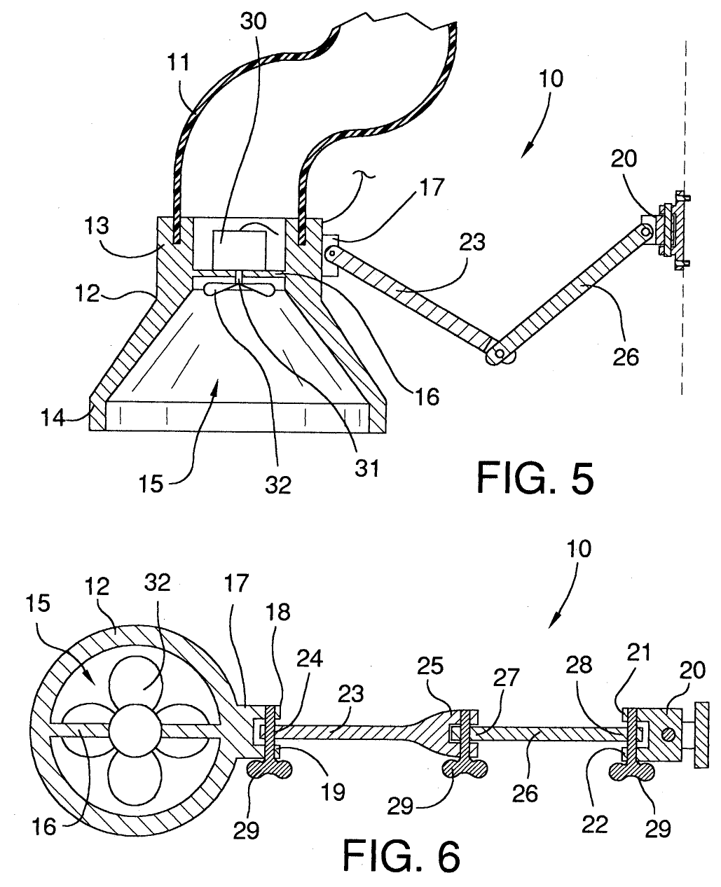

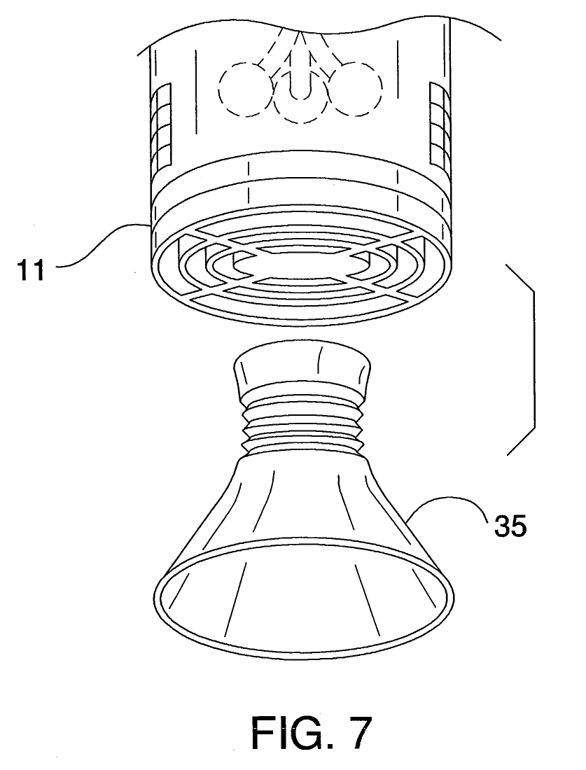

With reference now to the drawings, and in particular to FIGS. 1 through 6 thereof, a new ventilation system for removal of hair spray fumes embodying the principles and concepts of the present invention and generally designated by the reference numeral 10 will be described.

As best illustrated in FIGS. 1 through 6, the ventilation system for removal of hair spray fumes 10 generally comprises a fume passage assembly including a tubular conduit 11 being adapted to be conventionally mounted to a building structure such as a ceiling, and also includes a hood 12 being conventionally attached at an end of the tubular conduit 11. The hood 12 includes an upper portion 13 and a flared lower portion 14, and also includes a passageway 15 extending therethrough, and further includes a fan support member 16 being disposed in the passageway 15 and being securely and conventionally attached to a wall of the hood 12. As a second embodiment, the fume passage assembly further includes a first bracket 17 being securely and conventionally attached to an exterior of the hood 12, and also includes a second bracket 20 being adapted to be securely and conventionally mounted to the building structure, and further includes a first arm 23 having a first end 24 which is adjustably attached with a fastener 29 to the first bracket 17, and also includes a second arm 26 which has a second end 28 being adjustably attached with another fastener 29 to the second bracket 20 and which has a first end 27 being adjustably attached with yet another fastener 29 to a second end 25 of the first arm 23. Each of the first and second brackets 17,20 includes a pair of grommets 18,19 being spaced apart. The second end 25 of the first arm 23 is a yoke. The second end 28 of the second arm 26 is pivotally disposed and adjustably fastened between the pair of grommets 21,22 of the second bracket 20, and the first end 24 of the first arm 23 is pivotally disposed and adjustably fastened between the pair of grommets 18,19 of the first bracket 17. The first end 27 of the second arm 26 is pivotally disposed and adjustably fastened in the yoke of the first arm 23. The tubular conduit 11 is made of flexible material.

A means of drawing fumes through the hood 12 and the tubular conduit 11 includes a motor 30 having a rotatable shaft 31 and being conventionally mounted upon the fan support member 16, and also includes fan blades 32 being conventionally mounted to the rotatable shaft 31 and being disposed in the passageway 15 through the hood 12, and further includes a power switch 33 being conventionally connected to the motor 30 and being adapted to being conventionally mounted to the wall structure and being conventionally connected to a power supply, and also includes a timer switch 34 being conventionally connected to the motor 30 and being adapted to being conventionally mounted to the wall structure and to the power supply.

In use, the user would turn on the power switch 33 to activated the motor 30 which turns the fan blades 32 to draw the fumes through the hood 12 and through the tubular conduit 11 with the hood 12 being adapted to be placed proximate to where the fumes are being given off.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the ventilation system for removal of hair spray fumes. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A ventilation system for removal of hair spray fumes comprising:
a fume passage assembly including a tubular conduit being adapted to be mounted to a building structure such as a ceiling, and also including a hood being attached at an end of said tubular conduit; and
a means of drawing fumes through said hood and said tubular conduit.

2. A ventilation system for removal of hair spray fumes as described in claim 1, wherein said hood includes an upper portion and a flared lower portion, and also includes a passageway extending therethrough, and further includes a fan support member being disposed in said passageway and being securely attached to a wall of said hood.

3. A ventilation system for removal of hair spray fumes as described in claim 2, wherein said fume passage assembly further includes a first bracket being securely attached to an exterior of said hood, and also includes a second bracket being adapted to be securely mounted to the building structure, and further includes a first arm having a first end which is adjustably attached with a fastener to said first bracket, and also includes a second arm which has a second end being adjustably attached with another fastener to said second bracket and which has a first end being adjustably attached with yet another fastener to a second end of said first arm.

4. A ventilation system for removal of hair spray fumes as described in claim 3, wherein each of said first and second brackets includes a pair of grommets being spaced apart, and said second end of said first arm is a yoke.

5. A ventilation system for removal of hair spray fumes as described in claim 4, wherein said second end of said second arm is pivotally disposed and adjustably fastened between said pair of grommets of said second bracket, and said first end of said first arm is pivotally disposed and adjustably fastened between said pair of grommets of said first bracket.

6. A ventilation system for removal of hair spray fumes as described in claim 5, wherein said first end of said second arm is pivotally disposed and adjustably fastened in said yoke of said first arm.

7. A ventilation system for removal of hair spray fumes as described in claim 6, wherein said tubular conduit is made of flexible material.

8. A ventilation system for removal of hair spray fumes as described in claim 2, wherein said means of drawing fumes through said hood and said tubular conduit includes a motor having a rotatable shaft and being mounted upon said fan support member, and also includes fan blades being mounted to said rotatable shaft and being disposed in said passageway through said hood, and further includes a power switch being connected to said motor and being adapted to being mounted to the wall structure and being connected to a power supply, and also includes a timer switch being connected to said motor and being adapted to being mounted to the wall structure and to the power supply.
